(19) United States
(12) Patent Application Publication
(10) Pub. No.: US 2021/0189140 A1
(43) Pub. Date: Jun. 24, 2021

(54) PIGMENT COMPOSITION FOR SEED COATINGS

(71) Applicant: Sun Chemical Corporation, Parsippany, NJ (US)

(72) Inventors: Jonathan D. Doll, Cincinnati, OH (US); Jami Rae Bennett, Cincinnati, OH (US)

(21) Appl. No.: 17/195,819

(22) Filed: Mar. 9, 2021

Related U.S. Application Data
(63) Continuation of application No. PCT/US19/48563, filed on Aug. 28, 2019.
(60) Provisional application No. 62/728,923, filed on Sep. 10, 2018.

(51) Int. Cl. C09C 1/00; A01N 25/26

(52) U.S. Cl. CPC C09C 1/0081; A01N 25/26; C01P 2004/22; C01P 2006/90; C01P 2006/66; C01P 2004/61; C01P 2006/62; C01P 2006/65; C01P 2004/24

(57) ABSTRACT

A pigment composition comprising one or more filler particles and one or more pigments is useful as a seed coating. The pigment comprises one or more metal oxide coated filler particles. The composition does not comprise any materials that are no suitable for a seed coating. A coated seed is coated with the pigment composition.

### CROSS REFERENCE TO RELATED APPLICATIONS

The present application hereby claims the benefit of the provisional patent application of the same title, Ser. No. 62/728,923, filed on Sep. 10, 2018, the disclosure of which is herein incorporated by reference in its entirety.

### BACKGROUND

Seeds are coated with a colored coating so that farmers and/or seed distributor can quickly tell the difference between different strains and treatments of seeds. For this reason, a brightly colored seed is desired as it facilitates quick identification. Seed coatings will often be applied as an aqueous mixture that is dried at room temperature after application. If the coatings do not dry efficiently, it can lead to issues where the seeds stick together, decreasing their flowability and potentially leading to clogging of agricultural seed dosing equipment.

### BRIEF SUMMARY

A pigment composition comprising one or more filler particles and one or more pigments is useful as a seed coating. The pigment comprises one or more metal oxide coated filler particles. The composition does not comprise any materials that are no suitable for a seed coating. A coated seed is coated with the pigment composition.

These and other objects and advantages shall be made apparent from the description.

### DETAILED DESCRIPTION

Seeds are often treated with pigmented coatings to serve as a visual identifier and distinguish one type of seed or one type of seed treatment from another. For example, seeds are often coated so that pesticide-treated seeds are readily identifiable and do not enter the food stream. The pigment composition aids in the aesthetic of the seed coating by providing effects from a smooth uniform surface to a lustrous shimmer and spans a wide range of colors. An added effect is desired in a seed coating because it is eye catching in sunlight and yields pleasing aesthetics. By using the pigment composition as a seed coating in combination with an organic pigment, the chroma of the organic pigment is minimally dulled. When a pearlescent pigment alone is mixed with an organic colorant, the chroma of the organic pigment suffers. When a platelet shaped filler alone is mixed with an organic colorant, the resulting coating does not display the lustrous shimmer effect that is desired. Uniformity of the coating seeds is also enhanced with the use of the pigment composition as a seed coating.

The pigment composition, once dispersed into a pigmented seed coating system, or as the pigmented seed coating, can assist in drying and improve the flowability characteristics of a seed. In addition to drying and flowability, the composition also shows a decreased bleaching or washed out color produced by organic colorants, while also providing a unique luster and evenly colored seed. When used as a seed coating the pigment composition dries well on seeds and provides good flow characteristics while maintaining a high chroma and a good iridescent effect. When a seed coating has poor drying and flow characteristics, there is bridging between seeds and clogging of farm equipment that is used for seed dosing. Both of these reduce the rate at which the farmer can plant the seeds.

For example, if a pearlescent pigment is used in conjunction with an organic chromophore, the seed displays an iridescent effect and shows good flow and drying characteristics, however the color is bleached and only pastel colors are achievable. Using organic pigments alone gives the seed a strong color, but inferior drying and no iridescent effect and is often a non-uniform coating. The pigment compositions can be used to produce coated seeds that have strong iridescent colors in conjunction with good flow and drying properties.

The pigment composition comprises one or more filler particles and one or more pigments. The pigment comprises one or more metal oxide coated filler particles. The composition is suitable for a seed coating. A composition that is suitable for a seed coating must be one that at least, uses FDA approved compounds, allows the seed to germinate, is not toxic to the seed, and the coating is at least partially water-soluble. There may be additional requirements for the composition to be suitable for a seed coating.

The filler particles add texture and uniformity to the seed coating. In some embodiments, the filler particle is platelet shaped. The filler particle may be transparent or opaque. In some embodiments, the filler particle is homogeneous, meaning that all of the filler particles are made of the same material. In some embodiments, the filler particles are heterogeneous, meaning that the filler particles are comprised of more than one material. In some embodiments, the filler particles may differ in composition, particle size, crystal structure, and combinations thereof.

Examples of filler particles include, but are not limited to: natural mica, synthetic mica, glass, graphite, graphene, bismuth oxychloride, hexagonal boron nitride, aluminum oxide, aluminum hydroxide, potassium aluminum silicate, sodium aluminum silicate, ferric sulfate, zinc sulfate, potassium sulfate, magnesium sulfate, sodium sulfate, kaolin, phyllosilicate clay, calcareous shale, calcium carbonate, calcium phosphate, calcium oxide, calcium silicate, magnesium lime, montmorillonite clays, attapulgite clays, bentonite, hectorite, wollastonite, micaceous iron oxide, pyrophyllite, pearlite, calcite, diatomite, diatomaceous earth, vermiculite, coconut shells, wood flour, sand, soapstone, silicon dioxide, titanium dioxide, pearlescent pigments, aluminum, zinc, copper, brass, talc, dolomite, gypsum, zeolite, and mixtures thereof. In some embodiments, the filler particles are selected from: natural mica, synthetic mica, aluminum oxide, potassium aluminum silicate, sodium aluminum silicate, kaolin, calcium phosphate, pearlite, diatomaceous earth, aluminum, talc, gypsum, clay, and mixtures thereof. In some embodiments, the filler particles are selected from: natural mica, talc gypsum, aluminum, calcium phosphate, and mixtures thereof.

In some embodiments, the filler has a platelet shape. A platelet shape means that one dimension of the filler particle is dramatically smaller than the other two dimensions. The smaller dimension is typically called the height of the platelet and the largest dimension is called the diameter of the platelet. The ratio of the diameter divided by the height is called the aspect ratio. In some embodiments, the filler particle has a monodispersed size. In some embodiments, the filler particle comprises a distribution of particle sizes. In some embodiments, the platelet shaped filler particle may have a number of different shapes and need not be a true cylinder. For example, the platelet may be a polygon with >2 sides when viewed from the top. In some embodiments, the filler has a median particle size (d50) from about 1 to about 150 μm. In some embodiments, the d10 is greater than 3.0 μm, such as greater than 3.0 μm to about 5.0 μm, greater than 3.0 μm to about 10 μm, and greater than 3.0 μm to about 20 μm. In some embodiments, the platelet shaped filler particle has a distribution of heights, wherein the median filler height (h50) is from about 50 nm to about 1000 nm. In some embodiments the filler particles have an average aspect ratio, is in the range of about 10 to about 1000.

The pigment composition comprises one or more pigment. The pigment is one or more metal oxide coated filler particles. The filler particles used in the pigment may be the same particles used in the composition or they may be different. Examples of the metal oxide coatings include, but are not limited to silicon dioxide, titanium dioxide, zinc oxide, zirconium dioxide, tin oxide, cerium dioxide, vanadium (IV) oxide, manganese oxide, lead oxide, chromium oxide, iron oxide, aluminum oxide, tungsten oxide, and mixtures and alloys thereof. In some embodiments the metal oxide coatings are selected from silicon dioxide, titanium dioxide, tin oxide, zirconium oxide, iron oxide, aluminum oxide, zinc oxide, and combinations thereof. In some embodiments, the metal oxide coatings are selected from titanium dioxide, iron oxide, silicon dioxide, and combinations thereof. In some embodiments, the metal oxide coating additionally comprises a hydrated oxide of any of the aforementioned oxides. In some embodiments, the coating further comprises a dopant. Examples of dopants include, but are not limited to, salts comprising: Mn²⁺, Mn³⁺, Mn⁴⁺, Cr³⁺, Fe²⁺, Fe³⁺, Al³⁺, Zn²⁺, Ti⁴⁺, Cu¹⁺, Cu²⁺, PO₄²⁻, BO₃³⁻, and mixtures thereof.

In some embodiments, the thickness of the metal oxide coating is such that it allows partial transparency of a coating of the pigment composition. In some embodiments, the thickness of the metal oxide is from about 40 nm to about 1000 nm, such as about 45 nm to about 500 nm, and about 50 nm to about 350 nm.

In some embodiments, the pigment particle is pearlescent.

In some embodiments, the filler particles are about 70% to about 99% of the sum of the filler particles and the pigment particles (total filler particles), such as about 75% to about 95% and 75% to about 85%. In some embodiments, the pigment composition comprises about 50% to about 99% filler by weight, such as about 80% to about 99%. In some embodiments, the pigment composition comprises about 1% to about 50% pigment particles by weight, such as about 1% to about 20%. In some embodiments, the pigment composition comprises about 50% to about 99% filler by weight and about 1% to about 50% pigment particles by weight, such as about 80% to about 99% filler and about 1% to about 20% pigment particles by weight. In some embodiment, the pigment composition comprises about 1% to about 30% pigment by weight of the total filler particles, such as about 5% to about 25% and about 5% to about 15%.

In some embodiments, the pigment composition additionally comprises an organic colorant. The organic colorant may be used to yield a chromatic aesthetic that could not otherwise be achieved by the combination of metal oxide & filler alone. Examples of organic colorants include, but are not limited to azo pigments, polycylic pigments, anthraquinone pigments including monoazo pigments, disazo pigments, disazo condensation pigments, naphthol pigments, benzimidazolone pigments, isoindolinone pigments, isoindoline pigments, metal complex pigments, quinacridone pigments, perylene pigments, carbon black pigments, phthalocyanine pigments, perinone pigments, diketopyrrolo-pyrrole pigments, thioindigo pigments, anthropyrimidine pigments, flavanthrone pigments, anthanthrone pigments, dioxazine pigments, triarylcarbonium pigments, quinophthalone pigments, and combination thereof. Examples of pigments include, but are not limited to: FD&C Red 3, D&C Red 17, D&C Red 33, FD&C Red 40, CI Pigment Red 48:2, CI Pigment Red 112, FD&C Blue 1, FD&C Blue 2, CI Pigment Blue 15:3, FD&C Green 3, D&C Green 5, D&C Green 6, CI Pigment Green 7, D&C Violet 2, CI Pigment Violet 23, D&C Yellow 10, FD&C Yellow 5, FD&C Yellow 6, CI Pigment Yellow 1, Yellow 23, Yellow 42, Blue 15:1, Blue 29, Black 11, Black 7, White 6 and Red 101, and combinations thereof. In some embodiments, the composition is from about 0.1% to about 50% organic colorant by weight.

In some embodiments, the composition comprises water. In some embodiments, the composition comprises water and a polymer or surfactant selected from cellulose, methyl cellulose, ethyl cellulose, alginic acid, sodium alginate, chitosan, maltodextrin, xanthan gum, poly(acrylic acid), starch, poly(lactic acid), and combinations thereof.

The pigment composition additionally aids in seed flowability and drying time when incorporated into seed coatings. Platelet shaped fillers, when used alone and not coated with a metal oxide can excessively dry seeds, leading to desiccation and thus reducing the germination efficiency. In some embodiments, the incorporation of a metal oxide coating up to 30% of the filler particles prevents or minimizes desiccation and improves seed viability. In some embodiments, the flow rate is about 5.2 kg/min or more, such as 5.3 kg/min or more, 5.4 kg/min or more, 5.5 kg/min or more, and 5.6 kg/min or more. Examples include about 5.2 kg/min to about 5.9 kg/min, 5.3 kg/min to about 5.9 kg/min, 5.4 kg/min to about 5.9 kg/min, and 5.5 kg/min to about 5.9 kg/min.

The pigment composition can be incorporated into seed coatings which range in function and formulation and which are used to coat seeds of a wide range of sizes and shapes. The pigment compositions may be used in seed coatings that also contain other active materials such as for example, one or more additional colorants, fungicides, insecticides, antibiotics, zooicides, vaccines, flow agents, micronutrients, antidusting agents, chelating agents, binders, dispersants, antifreezing agents, sizing agents, thereby extending the growing season, changing the size of the seed, and creating a uniform seed shape and size, etc. In some embodiments, the pigment composition is incorporated in a seed coating in a preferable range of about 0.1% to about 25% by weight of the pigment composition.

In some embodiments, the pigment composition is applied as a post treatment during the seed coating process to aid in better drying and flow. In this case the seed is coated with a seed coating that does not contain the pigment composition. Before the seeds are dried, the pigment composition is added to the seeds to coat the outer layers of the seeds as described in WO2017/059197; the process of which is hereby incorporated by reference.

In some embodiments, the pigment compositions is used in seed coatings which are used to coat many types of seeds, including, for example tepary beans, runner beans, lima beans, pinto beans, kidney beans, black beans, appaloosa beans, green beans, moth beans, adzuki beans, mung beans, ground-beans, rice beans, cowpeas, chickpeas, peas, lentils, hyacinth beans, soybeans, winged beans, pigeon peas, velvet beans, guar, jack beans, sword beans, coffee beans, horse gram, black gram, green gram, lupin, peanuts, sorghum, corn, oats, rice, barley, rye, wheat, durum, spelt, kamut, amaranth, pitseed goose foot, kaniwa, quinoa, hanza, chia, flax, breadnut, sesame, buckwheat, beech nut, common bean, broad bean, Bambara groundnut, acorns, almonds, brazil nuts, candlenut, cashew, chestnuts, Chilean hazel, melon seeds, hazelnuts, hickory nuts, kola nuts, macadamia nuts, Malabar almond, Malabar chestnut, mamoncillo, mongongo, ogbono, paradise nut, pili, pistachio, walnuts, pine nuts, vegetable seeds, tree seeds, fruit seeds, shrub seeds, grass seeds, among others. The pigment composition may also be used in seed coatings which are used to coat varietals, breeds, hybrids and genetic variants of the above list as well as others not listed.

While the present disclosure has illustrated by description several embodiments and while the illustrative embodiments have been described in considerable detail, it is not the intention of the applicant to restrict or in any way limit the scope of the appended claims to such detail. Additional advantages and modifications may readily appear to those skilled in the art. Furthermore, features from separate lists can be combined; and features from the examples can be generalized to the whole disclosure.

### EXAMPLES

### Example

Natural mica filler having a d₅₀˜15 μm (90 g, Sun Chemical, USA) and silver pearlescent pigment having a d₅₀˜30 μm (10 g, Sun Chemical, USA) were combined to give a white powder.

### Comparative Example 2

Natural mica filler having a d₅₀˜15 μm (Sun Chemical, USA).

### Comparative Example 3

Titanium dioxide pigment (TiO₂) (Sun Chemical, USA).

### Comparative Example 4

Silver pearlescent pigment having a d₅₀˜30 μm (Sun Chemical, USA).

### Comparative Example 5

The pigment of Comparative Example 2 (97.2 g, natural mica filler) and 2.8 g of the pigment of Comparative Example 3 (TiO₂ pigment) were combined to give a white powder.

### Comparative Example 6

Red 48:2 organic pigment (30.4 g) was dispersed in 69.6 g of water.

### Example 7: Seed Coating

Examples 1 through 6 were formulated into a seed coating according to the amounts shown in Tables 1 and 2.

TABLE 1
Three-part seed coating formulation used for testing

| Component | wt. % | Phase |
|---|---|---|
| Water | 35 | I |
| Atlox 4913 (Croda) | 4.3 | |
| Tween 22 (Croda) | 1.5 | |
| Surfynol 104A (Evonik) | 0.1 | |
| Proxel GXL (Lonza) | 0.1 | |
| PEG 400 | 5 | |
| Rhodapol 23 (Solvay) | 0.15 | II |
| Propylene glycol | 4.85 | |
| Water¹ | Balance to 100 | III |
| Comparative Example 6 | See Table 2 | |
| Pigment Mixture | See Table 2 | |

¹Water is used to make up the balance of the formula to 100 parts.

An active material may be incorporated into phase III of the seed coating to provide added benefits to the seed. Such ingredients may include, but are not limited to, fungicides, insecticides, antibiotics, zooicides, vaccines, flow agents, micronutrients, anti-dusting agents, chelating agents, binders, dispersants, anti-freezing agents, sizing agents, agents which extend the growing season, agents which change the size of the seed, and agents which create a uniform seed shape and size, etc. The active material is at the discretion of the seed coating formulator. For testing purposes, water was used instead of any active ingredients.

TABLE 2
Specific composition for individual examples of Phase III from Table 1.

| | | | Wt % | Wt % | |
|---|---|---|---|---|---|
| | Wt % | Pigment | Pigment | Comparative | |
| Example | Water | Mixture | Mixture | Example 6 | Description |
| Example 7-1 | 39 | Example 1 | 10 | 0 | mica/pearl |
| (inventive) | | | | | |
| Example 7-2 | 39 | Comparative | 10 | 0 | mica |
| (comparative) | | Example 2 | | | |
| Example 7-3 | 46.2 | Comparative | 2.8 | 0 | TiO₂ |
| (comparative) | | Example 3 | | | |
| Example 7-4 | 39 | Comparative | 10 | 0 | pearl |
| (comparative) | | Example 4 | | | |
| Example 7-5 | 39 | Comparative | 10 | 0 | mica/TiO₂ |
| (comparative) | | Example 5 | | | |
| Example 7-6 | 29.3 | None | 0 | 19.7 | organic red |
| (comparative) | | | | | pigment |
| Example 7-7 | 19.3 | Example 1 | 10 | 19.7 | mica/pearl/ |
| (inventive) | | | | | organic red |
| Example 7-8 | 19.3 | Comparative | 10 | 19.7 | mica/organic |
| (comparative) | | Example 2 | | | red |
| Example 7-9 | 26.3 | Comparative | 2.8 | 19.7 | TiO₂/organic |
| (comparative) | | Example 3 | | | red |
| Example 7-10 | 19.3 | Comparative | 10 | 19.7 | pearl/ |
| (comparative) | | Example 4 | | | organic red |
| Example 7-11 | 19.3 | Comparative | 10 | 19.7 | mica/TiO₂/ |
| (comparative) | | Example 5 | | | organic red |

Table 1 outlines the general seed coating formulation used, where phase III is variable. Table 2 displays phase III components for each example. To make the seed coating formulation, the components of Phase I were combined and mixed. Separately, the components of phase II were combined until thoroughly mixed. Phase II was then added to phase I and homogenized for 15 min to make the base mixture. Phase III is then added to the base mixture to produce the final seed coating formulation. The individual formulation of the Phase III for the different examples is provided in Table 2.

### Example 8: Color Measurement

The seed coating formulations of Example 7-6 through 7-11 were drawn down on an uncoated black and white paper using a 1.5 mil bird applicator, then allowed to air dry for 30 min., then oven dried at 60° C. for 30 min. Note that Examples 7-1 to 7-5 were not included in the color measurement testing since they did not contain the organic red pigment. However, Examples 7-1 to 7-5 are still relevant since there are applications where end users may not want use colorants in their see coating. Diffuse color readings and multiangle color readings were taken using a Datacolor SF600 plus and a BYK-mac i-23 mm multiangle spectrophotometer, respectively. Table 3 shows the L*C*h* color data and the calculated strength over a white background measured in the diffuse sphere configuration and the sparkle intensity (Si) at 15o incident light angle measured over a black background. The value L* represents the brightness or whiteness, the Value C* represents the Chroma or intensity of a color and the value h* represents the hue of a color. h* is an angular quantity used to describe the direction of color vector C* within the CIELAB color space.

The diffuse color measurements in Table 3 show that Examples 7-7 through Example 7-11 are less chromatic and bluer than the untinted pigment of Example 7-6. Of these Examples, 7-10 loses the most chroma and has the largest shift in color. In addition to the shift in color, Example 7-10 shows the largest decrease in color strength when it is tinted with the pearlescent pigment of Example 4. In comparison, the inventive preparation of Example 7-7 (Example 1) shows less of a color shift (h*) and reduction in chroma when compared to Example 7-10. Example 7-9, which uses Example 3 as the inorganic pigment preparation, has a lower strength and is bluer than Example 7-7. In terms of color space, Example 7-7 is similar to Example 7-8 and 7-11 when measured diffusely. However, as can be seen in Table 3, the use of the multiangle measurements tells a different story.

The Sparkle intensity or Si is a measurement of the intensity of the flashes of light (i.e. sparkle) observed at a specific viewing angle, Si(15) is the Sparkle intensity at a viewing angle of 15. It is measured using the BYK-mac multiangle spectrophotometer. When Example 7-7 is compared to Examples 7-8 and 7-11, a clear difference in the sparkle is observed, indicative of the unique and surprising sparkle effect seen when using Example 1 in a seed coating. See Table 3.

TABLE 3
Diffuse and Multiangle Color Measurements for
Tinted samples in Examples 7-6 through 7-11.

| | Inorganic | | | | | |
|---|---|---|---|---|---|---|
| | Pigment | | | | | Multi angle color |
| | Preparation | Diffuse Color Measurements | | | | measurement |
| Example | used | L* | C* | h* | Strength | Si(15) |
| Example 6 (comparative) | None | 44.9 | 52.7 | 52.7 | 100.0 | 4.3 |
| Example 7-7 (inventive) | Example 1 | 47.9 | 46.8 | 47.8 | 51.5 | 11.8 |
| Example 7-8 (comparative) | Example 2 | 47.4 | 47.8 | 49.6 | 57.9 | 6.4 |
| Example 7-9 (comparative) | Example 3 | 46.0 | 43.9 | 43.8 | 49.3 | 8.7 |
| Example 7-10 (comparative) | Example 4 | 52.0 | 37.6 | 28.6 | 18.8 | 22.5 |
| Example 7-11 (comparative) | Example 5 | 47.7 | 47.4 | 49.9 | 56.5 | 6.8 |

### Example 9 Seed Treatment

The seed coating formulations of Example 7 were used to treat soy beans. The soy beans were treated by adding 250 g of beans to a quart paint can with 1.75 g of seed coating formulation from Example 7. The can was mixed on a roller table for 2 min. Six of these containers were made and mixed simultaneously to coat a total of 1500 g of treated soy beans. Once the cans were finished rolling, the lid of each can was removed and set on top of the can loosely to allow the beans to dry overnight. Example 9-1 were soy beans treated with a seed coating which had a Phase III of Example 7-1. Example 9-2 were soy beans treated with a seed coating which had a Phase III of Example 7-2, and so forth.

### Example 10—Seed Flow

Once the coated seeds of Example 9 were fully dry, 1000 g of the coated seeds were timed for how fast they were able to flow through a 2.5 cm diameter opening. The apparatus used for such an experiment included a funnel which had a controlled release opening at the bottom. The seeds were loaded into the funnel with the release opening in the closed position, then once it was opened the seeds were timed using a stopwatch until they drained from the funnel. The results were then converted into the weight of seeds that can flow per minute. A higher value indicates a higher flow rate. This was repeated 5 times to obtain an average. Results are reported in table 4. Note that flow rate differences of only 0.1 kg/min are significant when seeds are being unloaded on an industrial scale, typically on the order of tons.

TABLE 4
Results of Seed Flowability of Example 10

| | Organic pigment | Inorganic Pigment | Average time |
|---|---|---|---|
| Example | present (y/n) | Preparation used | (kg/min) |
| Example 9-1 | n | Example 1 | 5.9 |
| (inventive) | | | |
| Example 9-2 | n | Example 2 | 5.7 |
| (comparative) | | | |
| Example 9-3 | n | Example 3 | 5.5 |
| (comparative) | | | |
| Example 9-4 | n | Example 4 | 5.8 |
| (comparative) | | | |
| Example 9-5 | n | Example 5 | 5.7 |
| (comparative) | | | |
| Example 9-6 | y | None | 5.1 |
| (Comparative) | | | |
| Example 9-7 | y | Example 1 | 5.2 |
| (inventive) | | | |
| Example 9-8 | y | Example 2 | 5.1 |
| (comparative) | | | |
| Example 9-9 | y | Example 3 | 4.9 |
| (comparative) | | | |
| Example 9-10 | y | Example 4 | 5.1 |
| (comparative) | | | |
| Example 9-11 | y | Example 5 | 5.2 |
| (comparative) | | | |

The results show that the flow rate of seeds treated with an organic pigment-containing coating (Examples 9-6 to 9-11) are lower than those without organic pigment (Examples 9-1 to 9-5). Moreover, the seeds treated with the pigment from Example 1 have the fastest flow rate within their class. When treated with a combination of Example 1 and Example 6 (Example 9-7), the results show that the seeds are among the fastest flowing of all the organic pigment modified samples.

This data, combined with the color data presented in Table 3 demonstrates the unique optical and functional properties of the inorganic pigment preparations.

Those skilled in the art having the benefit of the teachings of the present invention as hereinabove set forth, can effect numerous modifications thereto. These modifications are to be construed as being encompassed within the scope of the present invention as set forth in the appended claims.

What is claimed is:

1. A pigment composition comprising one or more filler particles and one or more pigments, wherein the pigment comprises one or more metal oxide coated filler particles, wherein the composition is suitable for a seed coating.

2. The composition of claim 1, wherein the filler particle and the pigment are platelet shaped.

3. The composition of claim 1, wherein the filler particle is selected from natural mica, synthetic mica, glass, graphite, graphene, bismuth oxychloride, hexagonal boron nitride, aluminum oxide, aluminum hydroxide, potassium aluminum silicate, sodium aluminum silicate, ferric sulfate, zinc sulfate, potassium sulfate, magnesium sulfate, sodium sulfate, kaolin, phyllosilicate clay, calcareous shale, calcium carbonate, calcium phosphate, calcium oxide, calcium silicate, magnesium lime, montmorillonite clays, attapulgite clays, bentonite, hectorite, wollastonite, micaceous iron oxide, pyrophyllite, pearlite, calcite, diatomite, diatomaceous earth, vermiculite, coconut shells, wood flour, sand, soapstone, silicon dioxide, titanium dioxide, pearlescent pigments, aluminum, zinc, copper, brass, talc, dolomite, gypsum, zeolite, and mixtures thereof.

4. The composition of claim 1, wherein the pigment is a metal oxide coated filler particles, wherein the metal oxide is selected from silicon dioxide, titanium dioxide, zinc oxide, zirconium dioxide, tin oxide, cerium dioxide, vanadium (IV) oxide, manganese oxide, lead oxide, chromium oxide, iron oxide, aluminum oxide, tungsten oxide, and mixtures and alloys thereof.

5. The composition of claim 1, wherein the pigment is pearlescent.

6. The composition of claim 1, further comprising one or more organic pigments.

7. The composition of claim 1, wherein the pigment comprises about 1% to about 30% by weight of the total filler particles.

8. The composition of claim 1, wherein the pigment comprises about 5% to about 25% by weight of the total filler particles.

9. The composition of claim 1, wherein the pigment comprises about 5% to about 15% by weight of the total filler particles.

10. The composition of claim 1, further comprising an additive selected from colorants, fungicides, insecticides, antibiotics, zooicides, vaccines, flow agents, micronutrients, antidusting agents, chelating agents, binders, dispersants, antifreezing agents, sizing agents, and combinations thereof.

11. The composition of claim 1, further comprising water and a polymer or surfactant selected from cellulose, methyl cellulose, ethyl cellulose, alginic acid, sodium alginate, chitosan, maltodextrin, xanthan gum, poly(acrylic acid), starch, poly(lactic acid), and combinations thereof.

12. The composition of claim 11, wherein the multiangle color measurement (Si(15)) is about 10 or more.

13. The composition of claim 12, wherein the seed flow rate is about 5.2 kg/min or more.

14. The composition of claim 13, further comprising one or more organic pigments.

15. The composition of claim 14, wherein the filler particles comprise mica.

16. The composition of claim 15, wherein the filler particles and pigment are from about 0.1% to about 25 wt. % of the composition.

17. The composition of claim 15, wherein the filler particles and pigment are from about 3 to about 20 wt. % of the composition.

18. The composition of claim 15, wherein the filler particles and pigment are from about 5 to about 15 wt. % of the composition.

19. A coated seed comprising a seed, wherein the seed is coated with the composition of claim 1.

20. A coated seed of claim 19, wherein the composition further comprises one or more organic pigments.
